(19) United States
(12) Patent Application Publication
(10) Pub. No.: US 2025/0044068 A1
(43) Pub. Date: Feb. 6, 2025

(54) CENTERING APPARATUS

(71) Applicant: Johnnie Turner, Liberty, TX (US)

(72) Inventor: Johnnie Turner, Liberty, TX (US)

(21) Appl. No.: 18/229,155

(22) Filed: Aug. 1, 2023

(51) Int. Cl. G01B 3/1084

(52) U.S. Cl. CPC G01B 3/1084; G01B 2003/1051; G01B 2003/1087

(57) ABSTRACT

A centering apparatus for facilitating alignment with a center of a surface of an object includes a housing containing a pair of coiled rule blades. The rule blades are extendable from the housing in opposite directions from each other and are operably interconnected such that the rule blades extend an equal distance away from the housing when one of the pair of rule blades is urged to extend away from the housing. A laser emitter is mounted to the housing and is centered between free ends of the pair of rule blades with respect to the housing. The laser emitter directs a laser away from the housing to facilitate alignment to measure center of a surface of an object.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to centering apparatuses and more particularly pertains to a new centering apparatus for facilitating alignment with a center of a surface of an object.

### (2) Description of Related Art Including Information Disclosed Under 37 CFR 1.97 and 1.98

The prior art describes centering apparatuses which use operably interconnected rule blades to extend opposite directions from a housing at equal distances to identify a center of a surface. However, the prior art does not describe an apparatus which directs a laser perpendicularly away from the center of the surface to facilitate aligning another object with the center of the surface. Such an apparatus is desirable, for example, when vertically aligning a picture frame with a center of a top horizontal surface of a window frame, piece of furniture, or the like.

### BRIEF SUMMARY OF THE INVENTION

An embodiment of the disclosure meets the needs presented above by generally comprising a housing having a pair of ends. The housing has a first side and a second side which are positioned opposite each other and extend between the pair of ends of the housing. The housing also has a third side and a fourth side which are positioned opposite each other and extend between the pair of ends of the housing and between the first and second sides. A pair of rule blades is mounted in the housing, and each rule blade of the pair of rule blades is positioned in a coiled configuration. The rule blades are extendable from the housing in opposite directions from each other along a measurement plane which is parallel to the first side of the housing. The rule blades are operably interconnected such that both of the pair of rule blades extend an equal distance away from the housing when one of the pair of rule blades is urged to extend away from the housing. A laser emitter is mounted on the second side of the housing and is centered between free ends of the pair of rule blades with respect to the housing. The laser emitter is oriented to emit a laser away from the housing along a line extending perpendicular to the measurement plane.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a centering apparatus according to an embodiment of the disclosure.

FIG. 2 is a front view of an embodiment of the disclosure.

FIG. 3 is a bottom view of an embodiment of the disclosure.

FIG. 4 is a top view of an embodiment of the disclosure.

FIG. 5 is a side view of an embodiment of the disclosure.

FIG. 6 is a cross-sectional view of an embodiment of the disclosure taken from Arrows 6-6 in FIG. 5.

FIG. 7 is an exploded view of a spool, a linkage, and a bearing of an embodiment of the disclosure.

FIG. 8 is a block diagram of an embodiment of the disclosure.

FIG. 9 is an in-use view of an embodiment of the disclosure.

FIG. 10 is a perspective view of an alternative embodiment of the disclosure.

FIG. 11 is a side view of an alternative embodiment of the disclosure.

FIG. 12 is a cross-section view of an alternative embodiment of the disclosure taken from Arrows 12-12 in FIG. 11.

FIG. 13 is a block diagram of an alternative embodiment of the disclosure.

### DETAILED DESCRIPTION OF THE INVENTION

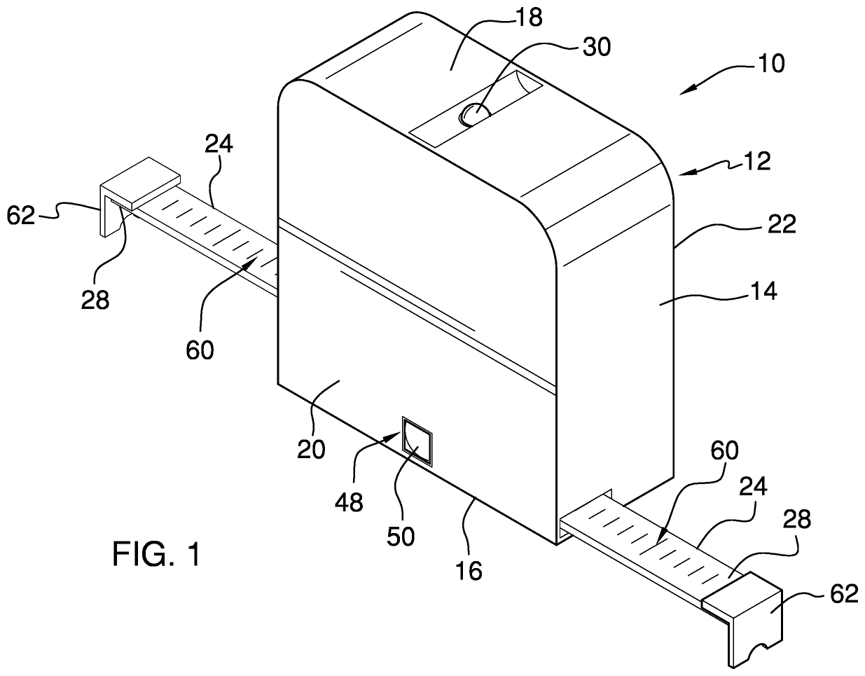

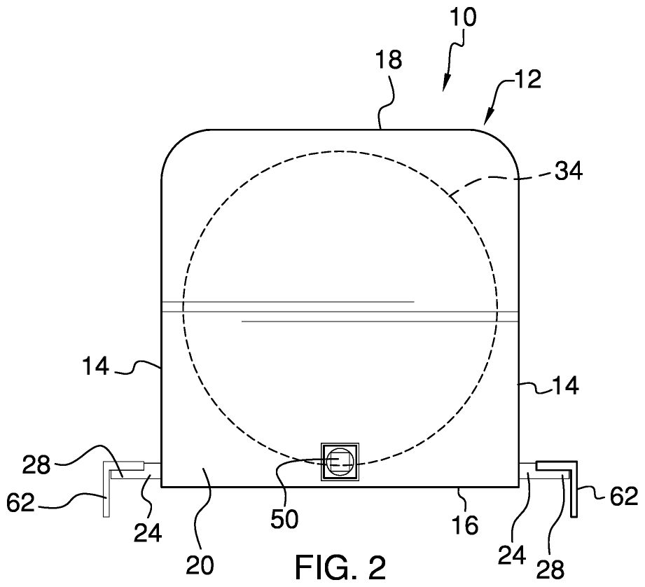

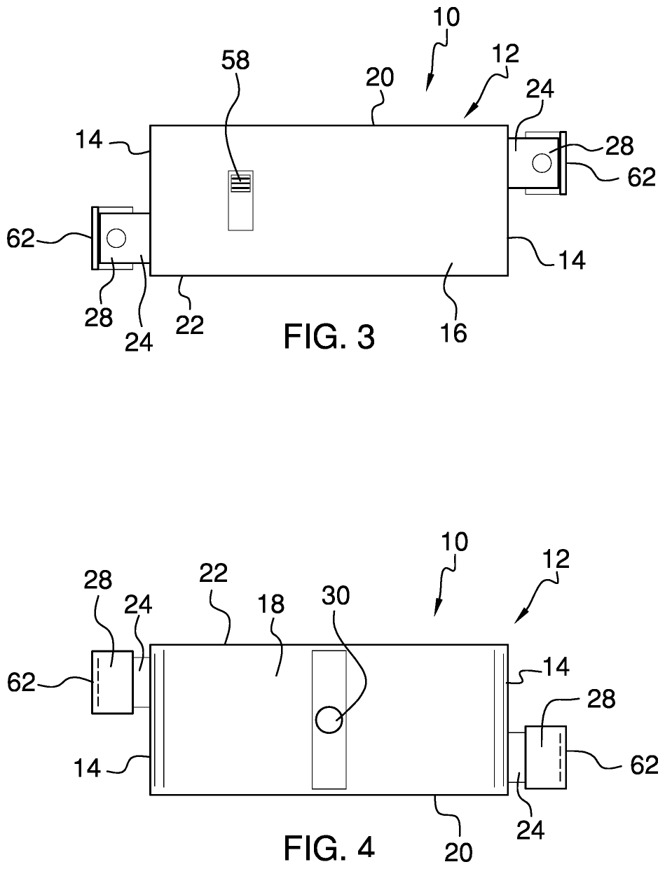

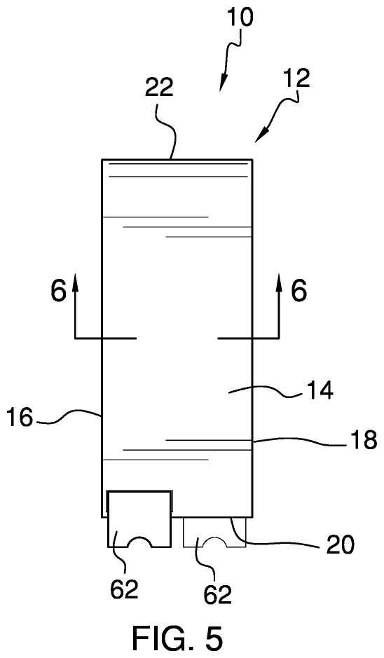

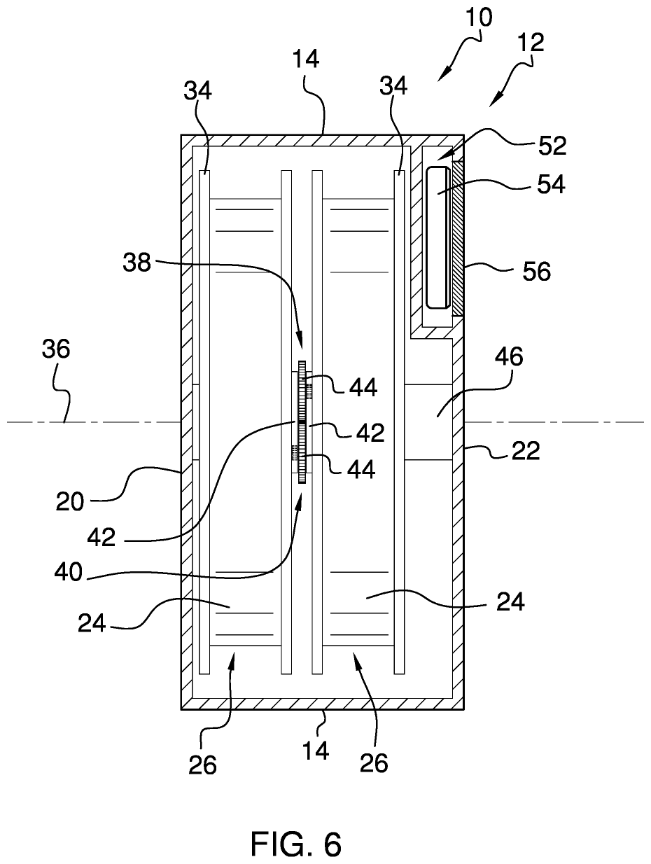

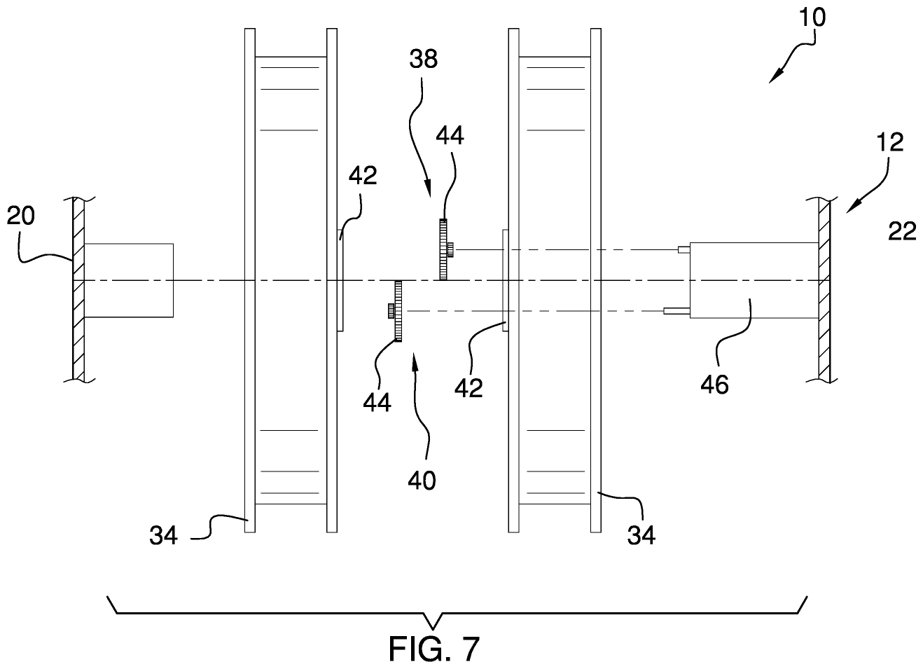

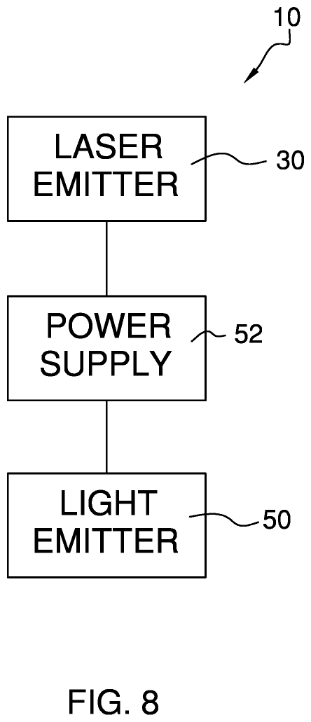

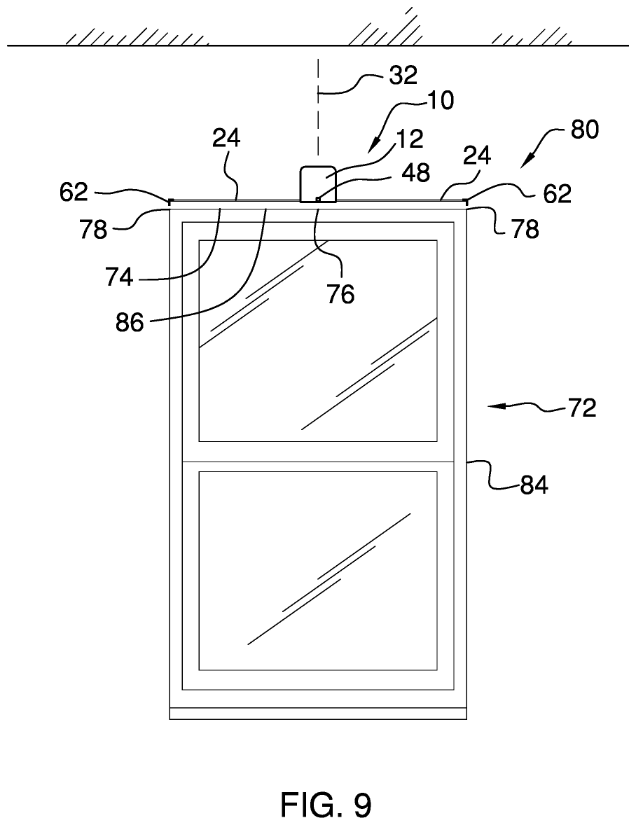

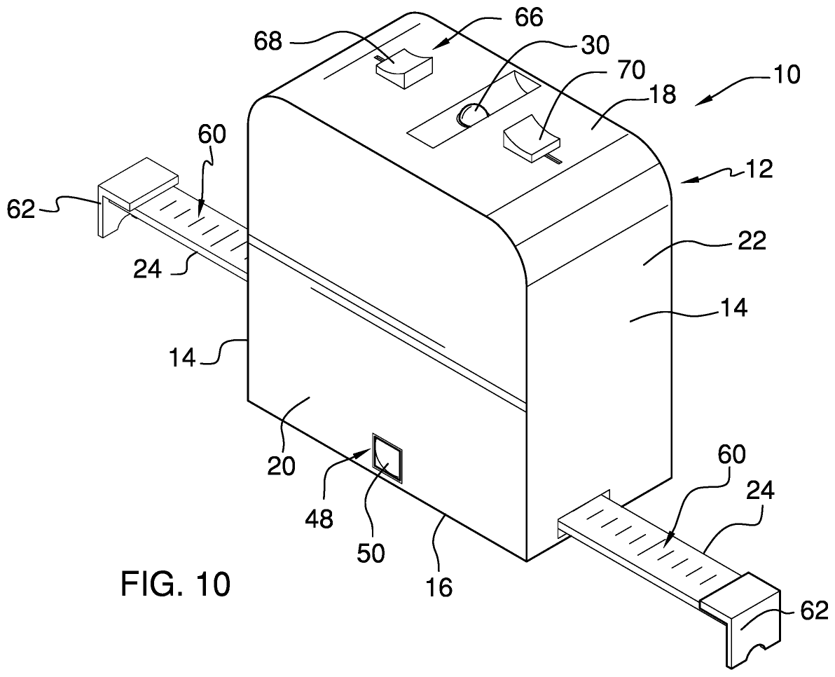

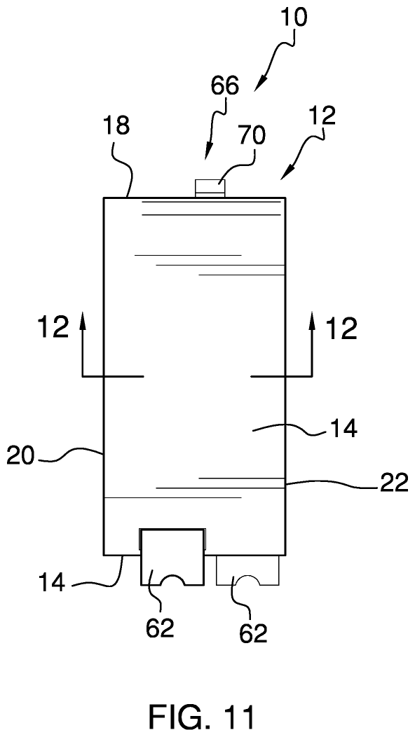

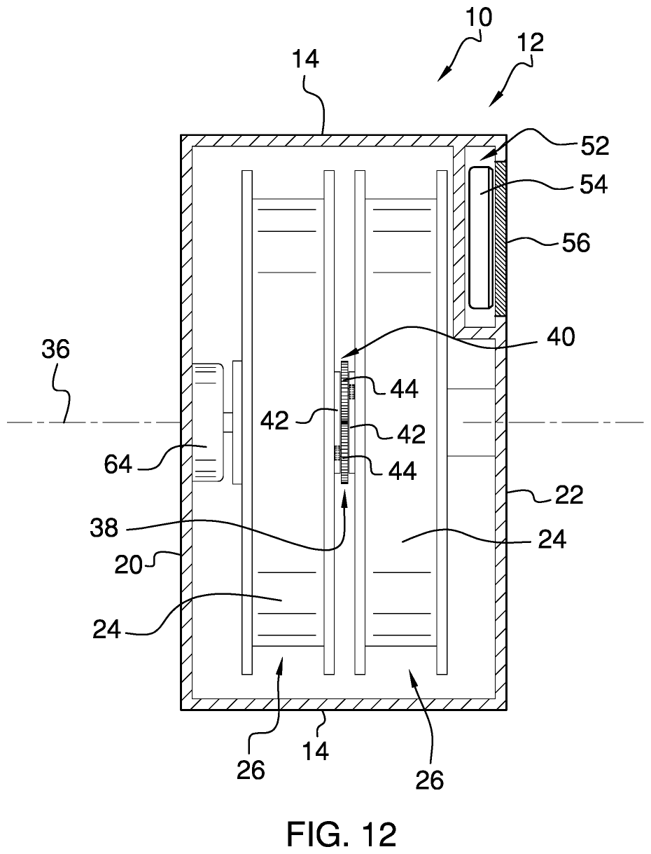

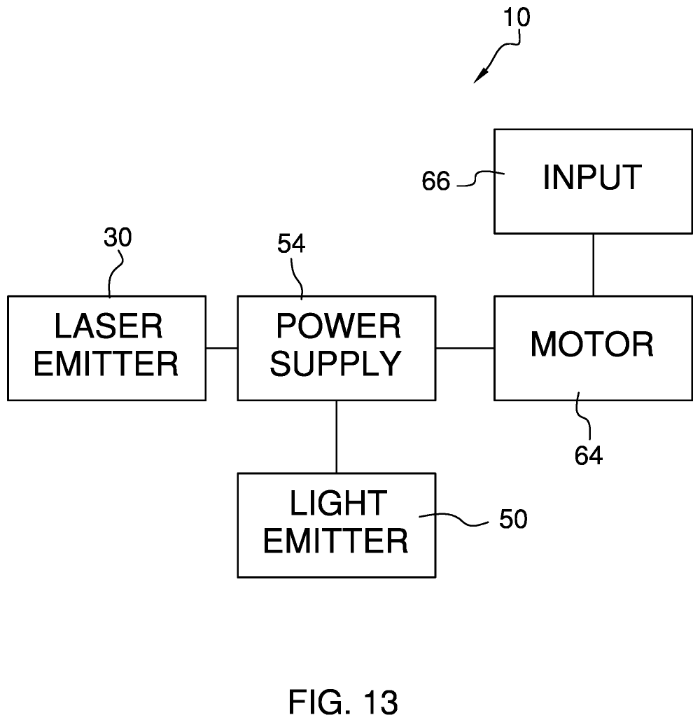

With reference now to the drawings, and in particular to FIGS. 1 through 11 thereof, a new centering apparatus embodying the principles and concepts of an embodiment of the disclosure and generally designated by the reference numeral 10 will be described.

As best illustrated in FIGS. 1 through 11, the centering apparatus 10 generally comprises a housing 12 having a pair of ends 14. The housing 12 has a first side 16 and a second side 18 which are positioned opposite each other and extend between the pair of ends 14 of the housing 12. The housing 12 also has a third side 20 and a fourth side 22 which are positioned opposite each other and extend between the pair of ends 14 of the housing 12 and between the first and second sides 16, 18.

A pair of rule blades 24 is mounted in the housing 12. Each rule blade 24 of the pair of rule blades 24 is positioned in a coiled configuration 26, and the rule blades 24 of the pair of rule blades 24 are extendable from the housing 12 in opposite directions from each other along a measurement plane parallel to the first side 16 of the housing 12. The rule blades 24 of the pair of rule blades 24 are operably interconnected such that both of the pair of rule blades 24 extend an equal distance away from the housing 12 when one of the pair of rule blades 24 is urged to extend away from the housing 12. The measurement plane is positioned adjacent to the first side 16 of the housing 12.

A laser emitter 30 is mounted on the second side 18 of the housing 12 and is centered between free ends 28 of the pair of rule blades 24 with respect to the housing 12. The laser emitter 30 is oriented to emit a laser 32 away from the housing 12 along a line extending perpendicular to the measurement plane.

A pair of spools 34 is rotatably mounted in the housing 12 and is rotatable around a shared axis 36. Each one of the pair of rule blades 24 is wound onto an associated one of the pair of spools 34. A linkage 38 operably interconnecting the pair of spools 34 such that both of the spools 34 rotate an equal rotational distance in opposite directions from each other when one of the pair of spools 34 is rotated around the shared axis 36. The linkage 38 comprises a geartrain 40. The geartrain 40 includes a pair of internal gears 42 and a pair of external gears 44. Each internal gear 42 of the pair of internal gears 42 are fixedly coupled to an associated one of the pair of spools 34. Each external gear 44 of the pair of external gears 44 is rotationally coupled to the housing 12. Each external gear 44 of the pair of external gears 44 engages each other and engages an associated one of the pair of internal gears 42. Each external gear 44 of the pair of external gears 44 is mounted to a bearing 46 about which one of the pair of spools 34 is rotatably mounted to mount the one spool 34 to the housing 12. The geartrain 40 also may comprise another conventional arrangement of gears, such as a pair of first bevel gears fixedly attached to associated ones of the pair of spools 34 and a pair of second bevel gears which each engage and extend between the pair of first bevel gears.

A center indicator 48 is mounted on the third side 20 of the housing 12 adjacent to the first side 16 and is centered between the free ends 28 of the pair of rule blades 24. The center indicator 48 comprises a light emitter 50. The light emitter 50 may be a light emitting diode or other conventional compact light emitting means. A power supply 52 is mounted in the housing 12 and is selectively electrically couplable to the laser emitter 30 and the light emitter 50. The power supply 52 comprises a battery 54. The battery 54 is accessible through a door 56 which is removably coupled to the housing 12 and is positioned on the fourth side 22 of the housing 12. A switch 58 is mounted on the housing 12 and is operable to electrically couple the power supply 52 to the laser emitter 30 and the light emitter 50. The switch 58 is positioned on the first side 16 of the housing 12.

Each one of a pair of measurement indicia 60 is coupled to an associated one of the pair of rule blades 24 to indicate a distance from the free end 28 of the associated rule blade 24. Each one of a pair of hooks 62 is coupled to the free end 28 of an associated one of the pair of rule blades 24.

A motor 64 is mounted in the housing 12 and is operatively coupled to one of the pair of spools 34. The motor 64 is operable to rotate the one spool 34 alternately in a first rotational direction and a second rotational direction around the shared axis 36 to cause the pair of rule blades 24 to alternately extend from and retract into the housing 12. The motor 64 is also electrically coupled to the power supply 52. An input 66 is mounted to the housing 12 and is electrically coupled to the motor 64. The input 66 is actuatable to operate the motor 64. The input 66 includes a deploy switch 68 for rotating the motor 64 to cause the pair of rule blades 24 to extend from the housing 12 and a retract switch 70 for rotating the motor 64 to cause the pair of rule blades 24 to retract into the housing 12.

In use, the centering apparatus 10 is operated to locate a center 76 of a surface 74 of a first object 72 and to project the laser 32 away from the center 76 so that a second object 78 may be aligned centrally to the first object 72. The centering apparatus 10 is positioned adjacent to the surface 74 of the first object 72, and the pair of rule blades 24 are extended to a deployed configuration 80 in which the free ends 28 of the pair of rule blades 24 are adjacent to opposing edges 78 of the surface 74. The laser emitter 30 is activated to project the laser 32 away from the center 76 and perpendicular to the surface 74. The second object 78 is then positioned in alignment with the center 76 of the surface 74 along the laser 32. The center indicator 48 may also be referenced to identify the center 76 of the surface 74.

More particularly, and as an example of the types of alignment sought when using the centering apparatus 10, the first object 72 may be a window frame 84, and the surface 74 of the first object 72 may be a top horizontal surface 86. The second object 78 may be a picture frame to be hung on a wall. When operated as described above, the centering apparatus 10 will project the laser 32 vertically upwardly from the center 76 of the top horizontal surface 86, facilitating vertically aligning of the picture frame relative to the center 76 of the window frame 84.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A centering apparatus comprising:
a housing having a pair of ends, the housing having a first side and a second side being positioned opposite each other and extending between the pair of ends of the housing, the housing having a third side and a fourth side being positioned opposite each other and extending between the pair of ends of the housing, the third and fourth sides extending between the first and second sides;
a pair of rule blades being mounted in the housing, each rule blade of the pair of rule blades being positioned in a coiled configuration, the pair of rule blades being extendable from the housing in opposite directions from each other along a measurement plane parallel to the first side of the housing, the pair of rule blades being operably interconnected such that both of the pair of rule blades extend an equal distance away from the housing when one of the pair of rule blades is urged to extend away from the housing; and
a laser emitter being mounted on the second side of the housing and being centered between free ends of the pair of rule blades with respect to the housing, the laser emitter being oriented to emit a laser away from the housing along a line extending perpendicular to the measurement plane.

2. The apparatus of claim 1, wherein the measurement plane is positioned adjacent to the first side of the housing.

3. The apparatus of claim 1, further comprising:
a pair of spools being rotatably mounted in the housing and being rotatable around a shared axis, each one of the pair of rule blades being wound onto an associated one of the pair of spools; and
a linkage operably interconnecting the pair of spools such that both of the spools rotate an equal rotational distance in opposite directions from each other when one of the pair of spools is rotated around the shared axis.

4. The apparatus of claim 3, wherein the linkage comprises a geartrain.

5. The apparatus of claim 1, further comprising a center indicator being mounted on the third side of the housing adjacent to the first side and being centered between the free ends of the pair of rule blades.

6. The apparatus of claim 5, wherein the center indicator comprises a light emitter.

7. The apparatus of claim 1, further comprising a power supply being mounted in the housing and being selectively electrically couplable to the laser emitter and the light emitter.

8. The apparatus of claim 7, wherein the power supply comprises a battery.

9. The apparatus of claim 7, further comprising a switch being mounted on the housing and being operable to electrically couple the power supply to the laser emitter and the light emitter, the switch being positioned on the first side of the housing.

10. The apparatus of claim 1, further comprising a pair of measurement indicia, each measurement indicia of the pair of measurement indicia being coupled to an associated one of the pair of rule blades to indicate a distance from the free end of the associated rule blade.

11. The apparatus of claim 1, further comprising a pair of hooks, each hook of the pair of hooks being coupled to the free end of an associated one of the pair of rule blades.

12. The apparatus of claim 3, further comprising a motor being mounted in the housing and being operatively coupled to one of the pair of spools, the motor being operable to rotate the one spool alternately in a first rotational direction and a second rotational direction around the shared axis to cause the pair of rule blades to alternately extend from and retract into the housing.

13. The apparatus of claim 12, further comprising an input being mounted to the housing and being electrically coupled to the motor, the input being actuatable to operate the motor.

14. The apparatus of claim 13, wherein the input includes a deploy switch for rotating the motor to cause the pair of rule blades to extend from the housing and a retract switch for rotating the motor to cause the pair of rule blades to retract into the housing.

15. A centering apparatus comprising:
a housing having a pair of ends, the housing having a first side and a second side being positioned opposite each other and extending between the pair of ends of the housing, the housing having a third side and a fourth side being positioned opposite each other and extending between the pair of ends of the housing, the third and fourth sides extending between the first and second sides;
a pair of rule blades being mounted in the housing, each rule blade of the pair of rule blades being positioned in a coiled configuration, the pair of rule blades being extendable from the housing in opposite directions from each other along a measurement plane parallel to the first side of the housing, the pair of rule blades being operably interconnected such that both of the pair of rule blades extend an equal distance away from the housing when one of the pair of rule blades is urged to extend away from the housing, the measurement plane being positioned adjacent to the first side of the housing;
a laser emitter being mounted on the second side of the housing and being centered between free ends of the pair of rule blades with respect to the housing, the laser emitter being oriented to emit a laser away from the housing along a line extending perpendicular to the measurement plane;
a pair of spools being rotatably mounted in the housing and being rotatable around a shared axis, each one of the pair of rule blades being wound onto an associated one of the pair of spools;
a linkage operably interconnecting the pair of spools such that both of the spools rotate an equal rotational distance in opposite directions from each other when one of the pair of spools is rotated around the shared axis, the linkage comprising a geartrain;
a center indicator being mounted on the third side of the housing adjacent to the first side and being centered between the free ends of the pair of rule blades, the center indicator comprising a light emitter;
a power supply being mounted in the housing and being selectively electrically couplable to the laser emitter and the light emitter, the power supply comprising a battery;
a switch being mounted on the housing and being operable to electrically couple the power supply to the laser emitter and the light emitter, the switch being positioned on the first side of the housing;
a pair of measurement indicia, each measurement indicia of the pair of measurement indicia being coupled to an associated one of the pair of rule blades to indicate a distance from the free end of the associated rule blade;
a pair of hooks, each hook of the pair of hooks being coupled to the free end of an associated one of the pair of rule blades;
a motor being mounted in the housing and being operatively coupled to one of the pair of spools, the motor being operable to rotate the one spool alternately in a first rotational direction and a second rotational direction around the shared axis to cause the pair of rule blades to alternately extend from and retract into the housing; and
an input being mounted to the housing and being electrically coupled to the motor, the input being actuatable to operate the motor, the input including a deploy switch for rotating the motor to cause the pair of rule blades to extend from the housing and a retract switch for rotating the motor to cause the pair of rule blades to retract into the housing.
